(19) United States
(12) Patent Application Publication
(10) Pub. No.: US 2011/0175553 A1
(43) Pub. Date: Jul. 21, 2011

(54) DISTRIBUTED LIGHTING CONTROL SYSTEM

(75) Inventor: Jeffrey B. Sampsell, Pueblo West, CO (US)

(73) Assignee: QUALCOMM MEMS Technologies, Inc., San Diego, CA (US)

(21) Appl. No.: 13/075,035

(22) Filed: Mar. 29, 2011

Related U.S. Application Data
(63) Continuation of application No. PCT/US2009/005559, filed on Oct. 8, 2009.
(60) Provisional application No. 61/104,460, filed on Oct. 10, 2008.

(51) Int. Cl. H05B 37/00; H05B 37/02

(52) U.S. Cl. 315/312; 315/152

(57) ABSTRACT

The Distributed Lighting Control System (DLCS) is based upon a distributed lighting system, which imbeds luminaire devices in structural materials such as ceiling tiles and wallboard. Each luminaire device is attached to a power network, and each luminaire device includes, or is directly associated with, an electronic circuit component that controls the activation and operation of the luminaire. In normal operation the power network is energized based on signals conveyed to the circuit through wireless means or through signals imposed upon the power grid. Said signals are generated by the DLCS-controller, which is resident within the structure that contains the DLCS.

CROSS-REFERENCE TO RELATED PATENT APPLICATIONS

This application is a continuation of International Application No. PCT/US2009/005559, filed Oct. 8, 2009, which claims the benefit of Provisional Application U.S. Application 61/104,460, filed Oct. 10, 2008. This application is also related to International Application No. PCT/US2009/005555, filed Oct. 8, 2009, which claims the benefit of Provisional Application U.S. Application 61/104,606, filed Oct. 10, 2008. The disclosures of all of the above-referenced applications are considered part of, and are incorporated by reference in, this disclosure.

### BACKGROUND OF THE INVENTION

This section is intended to provide a background or context to the invention that is, inter alia, recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

For both commercial and residential applications, consumers demand more complicated lighting systems, while also desiring flexibility and adaptability. Currently there are two predominant modes of lighting control in current use, neither or which provides the desired features.

The first method connects a number of lighting fixtures to a distinct and separate power feed dedicated to said lighting fixtures. This method is widely used in residential settings. The fixtures are activated and controlled by a switch, which is usually mounted in an electric box fixed to a wall. Power feeds are pulled to the switch box from the breaker box, and pulled from the switch box to the locations of the fixtures. In commercial structures these power feeds are required to be housed in conduit located behind the walls. Thus, post-construction modifications or repairs in both residential and commercial settings often require substantial demolition and reconstruction of walls and ceiling. The resultant expense and inconvenience can render all but the simplest of changes impractical. The switch enclosed in the switch box implements direct changes in the voltage in the feed line supplying electricity to lighting fixture.

The second method does not require a power feed distribution mapped to the grouping of lighting fixtures. Power feeds are brought to individual light fixtures in the most optimal arrangement possible and a separate electronic switch component is inserted between each lighting fixture and the power feed intended for that lighting fixture. Groups of these separate electronic switch components (which have no inherent serial-number-type address) may be manually programmed to have a common group address. Alternatively, some or all of the separate electronic switch components may be programmed with unique addresses that are not shared with any other separate electronic switch. Remote controls, that may reside in a current practice switch box or that may be handheld wireless devices are manually programmed with addresses matching the groups of lighting fixtures or the individually addressable lighting fixtures. In this way, the groups of lighting fixtures or the individual lighting fixtures can be controlled by the remote controls using signals propagated across the power feeds, wireless signals received directly by the separate electronic switches, or signals sent wirelessly to a repeating control which relays the signals across the power feeds.

Both current methods provide limited ability for control. The control of the light fixtures is based on control of the power being transmitted via the connected feed line. In both current practice modes the lighting fixtures themselves are turned off when power is removed from the fixture, turned on when power is applied to the fixture, and dimmed when power to the fixture is modulated.

One significant limitation in the currently available methods is the requirement of significant time and care during the installation of the lighting system. Lighting plans must be created prior to construction and followed in detail to assure that power feeds are properly routed from breaker boxes to both fixtures and switch boxes. Further, because the underlying conduit housing the feed lines (or, in residential settings, the underlying Romex™ pulled through holes drilled in the studs behind the walls) is typically inaccessible and not movable post-construction, great care must be taken in providing sufficient feed lines, switch boxes, and fixtures.

In the case where the second mode of current practice is used, the detailed care of routing can be reduced, but only in exchange for an increased care of programming the addresses of the separate electronic switch components and their associated remote controls. Also, in the second mode of current practice, there is the additional burden of installing the separate electronic switch components themselves.

In the case of the first mode of current practice, where control resides in a switch attached through a power feed directly to several illumination devices, all of the devices on the circuit must be controlled in parallel. They must all take the same action. Reconfiguring the control group requires physically reconfiguring the building infrastructure, which is often not feasible or desirable. Also, the nature of the control provided by the switch (such as on/off or dimming) is determined by the physical switch in the electrical box. To change fixture behavior, a skilled technician must replace the switch unit. In many cases a type of dimming that works with some fixtures (such as incandescent fixtures) will not function properly with a different fixture (such as a fluorescent fixture). In such a case the entire infrastructure (switch, wiring, and fixture) may have to be replaced to achieve the desired new functionality.

In the case where separate electronic switch components are placed between each fixture and its power feed, the switch components have no knowledge of the capabilities of the fixture. The module may be able to provide dimming, but the type of dimming must be matched to the fixture with which it is paired. Once again, if the fixture is changed, it may be necessary to change the controlling module as well.

In all current practice, installation is difficult, expensive, and time consuming. In all current practice, reconfiguration is difficult, expensive, and time consuming. In all current practice, the modes of control are limited and restricted in how they are applied to global sets of fixtures, groups of fixtures, and individual fixtures.

### SUMMARY OF THE INVENTION

In one embodiment, a system is provided for controlling lighting. The system includes, at least one luminaire assembly including an electric circuit, luminaire communication device, and a luminaire including a light emitting diode, the luminaire assembly having associated therewith a unique identifier. The luminaire assembly is configured to receive energy from a direct current power grid. At least one controller is provided and includes a controller communication device and a user interface configured to receiver input from a user. The luminaire communication device is configured to receive information from the controller communication device.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1A is an illustration of one embodiment of a control system of the present invention.

FIG. 1B is an illustration of one embodiment of the power grid as generalized in FIG. 1A.

FIG. 2A is a front view of one embodiment of a controller in accordance with the principles of the present invention.

FIG. 2B is a rear view of controller of FIG. 2A.

FIG. 3A illustrates a tile for use with the present control system.

FIG. 3B illustrates a ceiling tile grid for use with the present invention.

FIG. 4A is a flow chart depicting one embodiment of the steps for a luminaire receiving a message.

FIG. 4B is a flow chart depicting alternative steps for a luminaire receiving a message.

FIG. 5 is a flow chart depicting one embodiment of steps for a controller receiving a message.

FIG. 6 is a flow chart depicting one embodiment of steps for simple programming a grouping of luminaires.

FIG. 7 is a flow chart depicting one embodiment of steps for piecewise programming a grouping of luminaires.

### DETAILED DESCRIPTION OF THE PREFERRED EMBODIMENTS

The present invention is directed to systems and methods for providing distributed lighting control. The Distributed Lighting Control System (DLCS) 101 enables numerous luminaire 120s of different types and with different capabilities to be installed in varied types of installations without regard by installers as to what type of wire has been pulled or (except for the overarching concern of not overloading breakers and circuits) as to the details of what locations the wire has been pulled. The intelligence embedded in the controller and in the luminaire 120s themselves enables an unprecedented level of system control and enables that control to be instantiated post-installation. This dramatic shift in lighting configuration and installation dramatically reduces cost and complexity while increasing performance and flexibility.

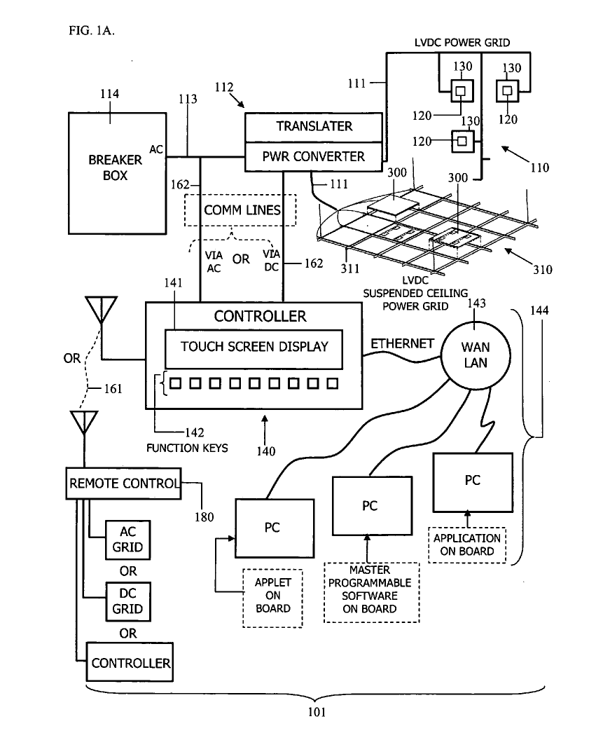

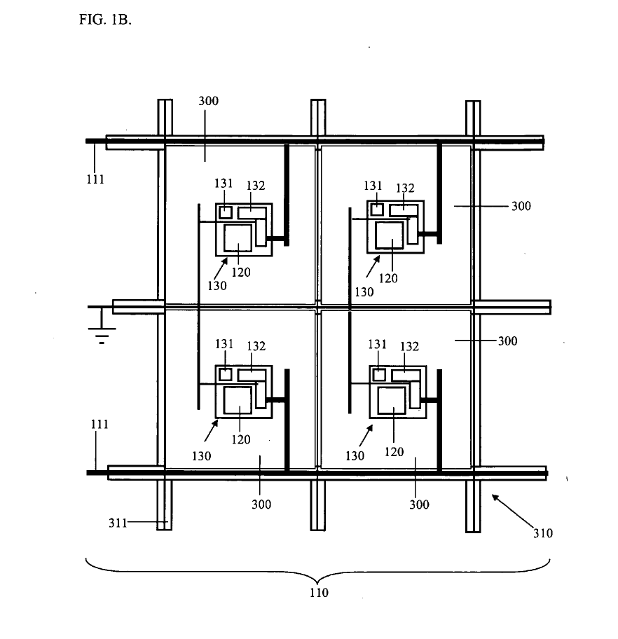

FIG. 1A illustrates one embodiment of the DLCS 101. In general, the DLCS 101 comprises a power grid 110, at least one luminaire 120 connected to the power grid 110, at least one controller 140, connected to the power grid 110, configured to control the luminaire 120, and a communication means for enabling the controller 140 to communicate with the luminaire 120. When power grid 110 is DC, it may include a power converter 112, an AC power feed 113 and a breaker box 114. In one embodiment, DLCS 101 as shown in FIG. 1A, further comprises a switch such as a remote control 180, a communication channel 161 from the remote 180 to the controller 140, and a communication channel 162 from the controller 140 to the luminaire 120.

FIG. 1B illustrates one generalized example of power grid 110 as it was represented in FIG. 1A wherein the electrical power is converted from AC to DC, and wherein each luminaire 120, in certain embodiments, is provided as part of a luminaire assembly 130, with one or more of the luminaire assemblies 130 contained in tiles 300 (e.g., overhead ceiling tiles), and one or more of the tiles 300 are contained in a supporting lattice 310 of members 311 (e.g., T-bar suspension rails) that suspend the tiles 300. Furthermore, in some embodiments described in the co-pending application entitled “Distributed Illumination System” filed concurrently herewith, supporting lattice 310 may be used as the electrical conduits for DC power and ground connections to tiles 300 and be so applied in accordance with the present invention. Luminaire assembly 130 includes, in addition to the luminaire 120, may further include a communication device 131, and an electronic circuit 132. The communication device 131 may be wired or wireless-type devices as are well known in the art.

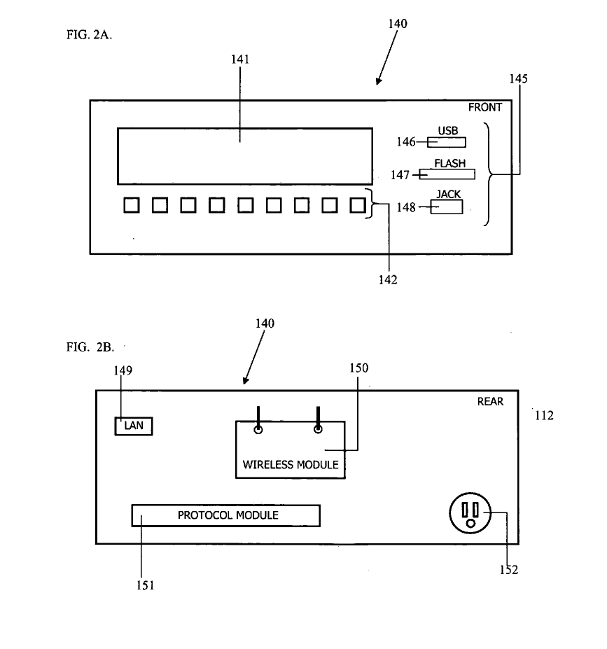

In one embodiment, the controller 140 shown in FIG. 1A includes a graphical user interface (GUI) 141 (which in one example may be a touch screen display), an input means 142 (which in one example may be a keyboard or keypad) and a connection to a network 143 (which in two examples may be a WAN or a LAN). The controller 140 is configured to communicate with the communication device 131 of the luminaire assemblies 130 connected to the OLCS 101. Further, the controller 140 may be configured to include or be in communication with a switch or remote 180 for providing user input remote from the controller's 140 location. The controller includes, in one embodiment illustrated in FIGS. 2A and 2B, at least one input means 145 such as a USB jack 146, a flash memory reader 147, and a connection jack for a handheld device 148. The controller of FIG. 2B further includes a network port 149, a power input 152 (e.g., AC or OC), a protocol module 151 to provide compatibility with power input system 152 (whether AC or DC) that is being used, and a controller communication device (such as a wireless module) 150 for allowing wireless communication with the remote 180 (in applications where a remote communications device is used) and the DC power grid 110 of luminaire assemblies 130.

In one embodiment practiced in accordance with the present invention, each luminaire 120 consists of one or more LEDs mounted on a thermally-conducting electronic circuit substrate, a secondary optical system located above the LED's designed to collect the light emitted by the LED's and deliver that light to the output aperture of the luminaire, an electronic circuit 132 in communication with the DLCS 101 controller 140, said circuit 132 designed to control the light output of the one or more LEDs, a substrate to support the electronic circuit 132, appropriate electrical attachments to the power grid 110, and a mechanical element or elements provided to hold and position the LED, the secondary optical system, the electronic circuit 132, any substrate provided to support the electronic circuit 132, and the attachments to the power grid 110.

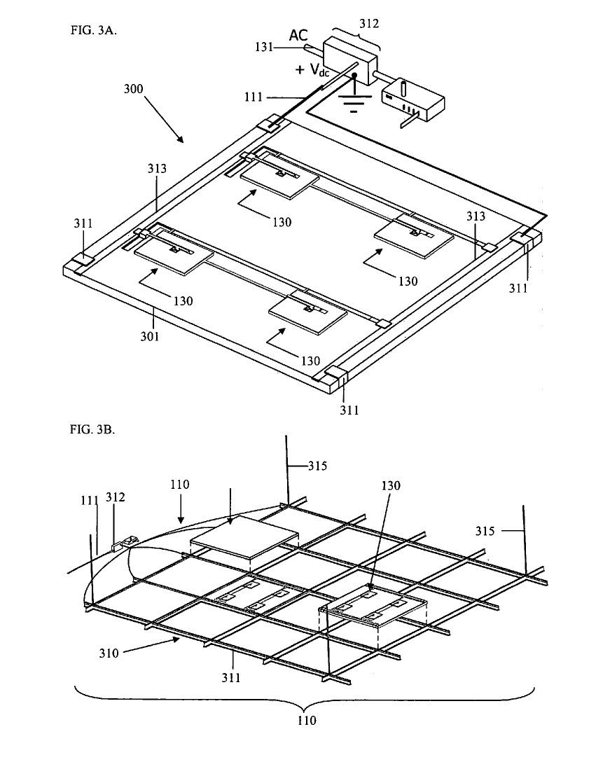

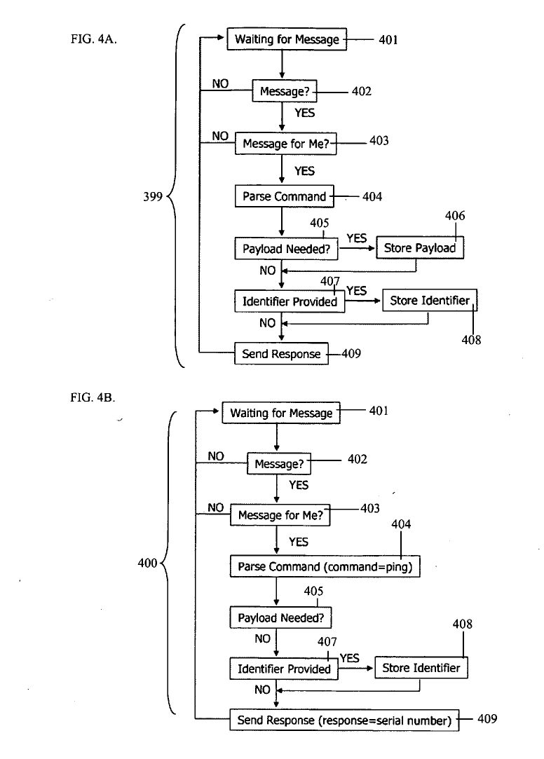

FIGS. 3A and 3B illustrate one embodiment of ceiling tile system usable with the present invention. The concurrently filed Application titled “Distributed Illumination System” describes one such system and is hereby incorporated by reference. FIG. 3A illustrates a ceiling tile 300 having a plurality of luminaire assemblies 130 (e.g., four such luminaire assemblies as one example) positioned (e.g., embedded within the body of ceiling tile material 301) therein that is taken from the concurrently filed Application titled “Distributed Illumination System”. The power grid 110 in this illustrated portion includes a power converter 312 and its connection to DC power grid 111, further includes a series of connecting tabs 311 and connecting busses 313. FIG. 3B illustrates one embodiment of an installation where such tiles 300 may be utilized in a suspended ceiling lattice structure 310 composed of suspending members 311 and suspending wires 315 as illustrated in FIG. 1B.

The electronic circuit 132 within each luminaire assembly 130 contains a unique identifier 126, such as a serial number, that can be used to identify the luminaire 120. Preferably, each luminaire assembly 130 contains at least one serial number 126 that is unique and permanent. In one embodiment, the serial number 126 is assigned to the luminaire 120 by a manufacturer of the luminaire 120, from a block of numbers provided to the manufacturer by a central party who ensures that each luminaire 120—for example, regardless of manufacturer has a unique identifier. In an exemplary embodiment, the unique identifier 126 is electronically embedded in the electronic circuit 132. In a further embodiment, the unique identifier 126 is affixed to the luminaire 120 in a machine-readable format. The manufacturer may choose, in certain embodiments, in addition to providing the electronically embedded unique identifier 126 in a human-readable version of the unique identifier 126 on the luminaire 120. The human-readable version could be affixed to the luminaire packaging as might be the machine-readable version as well.

Additionally, the luminaire assembly electric circuit 132 can hold one or more reprogrammable group addresses. These addresses essentially become an embedded expression of the lighting layout and plan for any given installation. The luminaire 120 can be assigned to various groups of luminaires 120 for achieving simultaneous control of various luminaires 120 to provide various lighting solutions. The addresses make up the “fabric” of the installed arrangement of luminaires 120 and controls in much the same way that the physical power feeds, physical light fixtures, and physical switches make up the “fabric” of current practice. Thus, a single luminaire 120 may be a member of a plurality of groups.

In certain embodiments, the electronic circuit 132 embedded in the luminaire assembly 130 may comprise a monolithic integrated circuit 134. That circuit 134 can be a microprocessor. The communication protocol between the DLCS 101 controller 140 and the luminaire 120 may be implemented in the luminaire 120 via software or it may be compiled into a block of custom circuitry hardware.

In addition to the monolithic circuit 134 mounted on a substrate 133 within the luminaire assembly 130, there may be discrete power components 135, in one embodiment mounted on a separate substrate, for switching the LEDs 121. It should be noted that in other embodiments the substrate 122 holding the LEDs 121 could be the same substrate 133 holding the embedded electronic circuit 132. Also, the power switching components may be contained within the monolithic circuit 134 rather than mounted separately on the substrate. The embedded electronic circuit 132 may be completely digital in nature or it may be a mixed-signal device containing both analog and digital functionalities. The circuit 132 may be constructed of a fully custom component, or an application specific integrated circuit (an ASIC), or a set of off-the-shelf components. In one embodiment, the luminaire communication device 131 is incorporated into the electric circuit 132.

In one embodiment, the DLCS 101 includes wireless communication capabilities including at least one remote control 180 that communicates with the DLCS 101 controller 140. In some embodiments, the DLCS 101 may include remote controls 180 that communicate directly to electronic circuits 132 within the luminaires 120. Preferably, the communication between the controller 140 and the luminaire circuit 132 is bi-directional. In one preferred embodiment the packets of information sent from the controller 140 to the luminaires 120 consist of four types of information: Address, Command, Payload, and Identifier. In turn, the luminaires 120 can respond with packets of information sent from the luminaires 120. The information sent by the luminaires 120 may include three types of information: Address, Payload, and Identifier. The types of information exchanged and the types of functionalities implemented by the DLCS 101 will be described in more detail below. In one embodiment, the controller 140 recognizes a unique custom remote in its basic implementation. Further, the controller 140 may also provide USB connectivity and Ethernet connectivity, as well as other such connectivities as known in the art. In on embodiment, a user may use any remote 180 that could talk to a computer, and then the application running on the computer could send the commands to the controller 140, for example, across the Ethernet. Alternatively, a dongle could be used, wherein a user plugs the dongle into the controller 140, and communicates with the controller 140 through the dongle. This capability (and the controller's network connectivity as well) allows a system owner to use his/her existing remote controls and system controllers to control the DLCS system capabilities.

In addition to communicating with the luminaires 120, the controller 140 can communicate with devices and systems 190 external to the DLCS 101. Non-limiting examples of such external communication include: wired and wireless remote controls 180, computer based applications connected through both wired and wireless channels, handheld programming devices, PDAs, smart-phones, etc. Additionally, in certain embodiments, the DLS 101 includes storage devices 191, which may be internal and integrated with the DLCS 101 or can communicate with external storage devices such as USB flash memory via one or more data ports. In such embodiments, the DLCS 101 controller 140 may be configured to load and execute script-based applications stored on the storage devices. In an exemplary embodiment, a set of executable instructions, such as a software program, are stored in the memory of the external devices to facility communication and interaction with the DLCS 101 controller 140.

In one embodiment, the controller 140 comprises a user interface. The user interface of the controller 140 may provide bidirectional information flows, i.e. the user is able to input information/commands and the user interface is able to provide the user with information via a display. In one embodiment, the user interface is a control module that may be fixed in place or movable. In one embodiment, the user interface is in communication with one or more computers. In an alternative embodiment, the user interface comprises a personal computer. For embodiments wherein more than one controller 140 is provided or wherein more than one computer is in communication with the control module, varying levels of control may be provided. For example, a first control module associated with a first controller 140a may provide the user with all functionality of the DLCS 101. A second control module associated with a second controller 140b may provide a user only with on/off functionality, but not with grouping/layer/planning functionality. A third control module associated with a third controller 140c may be provided with functionality to create and alter groups/layer/planning but not to control the on/off status of the luminaires 120.

In one embodiment, one or more luminaires may be controlled by electronic circuits external to the one or more luminaires, said circuits located for instance in the same building material that the luminaires are embedded in but located in a distinctly separate location from the luminaires. The DLCS can interface with these controlling circuits in the same manner that it interfaces with control circuits located on the luminaire. Furthermore, these externally located controlling electronic circuits can have addresses associated with them (as opposed to associated with the luminaires), addresses can then be associated by proxy with any luminaires that happen to be installed in the same building material and controlled by the circuit. These addresses, which in the case of circuits embedded in building materials could also be associated with the building materials themselves, become part of the aforementioned fabric of the lighting system. Luminaires having different addresses than the building material, or no addresses at all, may be switched in and out, but the address of the building material may remain the same.

### Controller Communication

FIG. 4A is a flow chart depicting one embodiment of the steps 399 for a luminaire receiving a message; FIG. 4B is a flow chart depicting alternative steps 400 for a luminaire receiving a message. Various methods are illustrated in FIGS. 4A and 4B, for receiving a message by the luminaire assembly 130. In one embodiment, the DLCS 101 controller 140 communicates with the luminaires 120 and various remote control devices using digital message packets. As previously discussed, the controller 140 may include a controller communication device 149 for facilitating the sending and receiving of information by the controller 140. The digital message packets may be communicated to the luminaires 120 in various ways known in the art, for example, but not limited to, passing along the power grid 110 or across a wireless connection to the luminaires 120. In one embodiment, the controller 140 sends messages to the luminaires 120 that can include Address, Command, Payload, and Identifier sections. The most fundamental type of communication from the controller 140 to a luminaire 120 (or group of luminaires 120) would be a command such as ‘turn off, ‘turn on’, or ‘dim to a certain level’. The dimming command can be an example of a communication that includes an Address (so the luminaire 120 can recognize that the message is meant for that specific luminaire 120), a Command (in this case to ‘dim’), and a Payload (representing the level of dimming to be executed). Alternatively, the ‘dim’ command could be sent without a Payload. The result being that the luminaire 120 would dim to the next lowest level of its dimming capability.

As illustrated in FIG. 4A, the luminaire assembly 130 waits for a message at step 401. At step 402, the luminaire assembly 130 checks if a message has been received. If no message is received, the luminaire assembly 130 returns to step 401 and waits for a message. If a message was received, the luminaire assembly 130 checks, at step 403, if the message is addressed to the luminaire assembly 130 (such as a broadcast message, a group message or an individual message). If the message was not addressed to the luminaire assembly 130, step 401 is returned to. If the message was addressed to the luminaire assembly 130, then the luminaire assembly 130 parses the commands in the message at step 404. Step 405 determines if a payload is needed. If a payload is needed, the payload is stored at step 406 and the luminaire assembly 130 proceeds to step 407. If no payload is needed, the luminaire assembly 130 proceeds to step 407, where it is determined if the message included an identifier. If an identifier was provided, the identifier is stored at step 408. At step 409, the command provided by the message is executed, and at 410 a response to the message is sent from the luminaire assembly 130 if such a response was indicated by the nature of the message.

Such fundamental commands can be sent to an individual (unique identifier 126) address, a group address, or a universal address that is recognized by all of the connected luminaires' 120. Universal addresses are pre-defined by a central party and reserved from the global pool of addresses. Every luminaire circuit 132 is programmed to recognize these universal messages. In one embodiment, the controller sends out the commands with an address. All luminaires 120 listen, i.e. they act if the address is relevant to them. In one embodiment, the luminaires 120 respond to three types of addresses: (1) UNIVERSAL (2) GROUP (3) INDIVIDUAL. The UNIVERSAL and INDIVIDUAL addresses are set by default, such as by being “burnt” in at the factory. The GROUP is learned post installation.

The controller 140 can send more complex messages. For instance, the controller 140 can send a message with Address and Command sections requesting the luminaire 120 to provide the controller 140 with a table of the luminaire 120 capabilities. The luminaire 120 responds with a Payload comprised of symbols describing what functionalities it supports. In a preferred embodiment, the controller 140 would be pre-programmed with a library of symbols and their corresponding capabilities and the luminaire 120 would utilize the same language of symbols, though it may only be pre-programmed with those symbols relating to the luminaire's 120 capabilities. The luminaire 120 capability information is stored within a database maintained by the controller 140. In certain embodiments, when installers and operators of the DLCS 101 system utilize the controller 140 to define lighting arrangements and lighting performance, this database provides input to a controller 140-based configuration application program or a configuration application located on a separate platform 144 (FIG. 1) such as a personal computer connected to the controller 140 through a Wan or LAN network. The application, armed with the capability database information, allows the user to determine the control options that are available.

The DLCS 101 is also configured to send “universal” messages, i.e. messages intended to be communicated to each luminaire 120 on the system. An exemplary universal message that the controller 140 can send is a ‘global ping’ message. FIG. 4B illustrates a method 400A of “pinging” luminaire assemblies 130 on the DLCS 101 to determine their unique identifier 126, so that it may be used for later messaging. At step 404, the command is parsed to determine that a “ping” is being made. The response from the luminaire assembly 130 is to provide the unique identifier 126 at step 409. The message contains at the least the appropriate universal address in its Address section, the ‘global ping’ command in its Command section, and the controller's address in its Identifier section. Every luminaire 120 responds to this message by sending to the controller 140 its unique identifier 126 as an Identifier. In this way the controller 140 can learn the addresses of every luminaire 120 attached to the power grid 110. Such a request can create a cacophony on the network, so, in one embodiment, another command available to the DLCS 101 controller 140 is ‘suppression of global ping response’. This request allows the controller 140 to switch-off responses from luminaires 120 when they have already been registered in the controller database, and when they are known to be resident on the network encompassing power grid 110. Another command often associated with a ‘global ping’ interaction is a ‘controller ID set’ in which the controller 140 sends its address to the luminaire 120 as an Identifier. This sets the luminaire 120 to send all responses to the designated controller 140 until a subsequent message might reset the ‘controller ID’ parameter.

It should be appreciated that the DLCS 101 controller 140 may utilize or be implemented, in part, on a computer running an appropriate operating system such as a Linux derivative. An overarching controller algorithm running within the operating system will express the user viewable controller personality and capability. In turn, the controller 140 capabilities will comprise a set of user features and control language commands that might include all of the exemplary commands described herein as well as many commands not mentioned herein. In one embodiment, all of the control maps are stored in the controller 140. In one embodiment flash memory is utilized.

The DLCS 101 controller 140, having learned the capabilities of a particular luminaire 120 or group of luminaires 120, can send messages that include Commands and Payloads that instruct the luminaires 120 to execute commands using a particular capability versus another capability. For example, a luminaire 120 may be capable of achieving a certain light output level by passing a steady-state current of a particular magnitude through an LED 121 (or LEDs 121). Alternatively, the luminaire 120 may be capable of achieving the same light output level by pulse-width-modulating the applied LED 121 current level between a maximum value and a minimum value of current. The controller 140 can select between these two methods by sending the proper command as specified by a capabilities message previously communicated to the controller 140 by the luminaire 120. Such capabilities are beyond the reach of current practice.

### Remote Control Communication

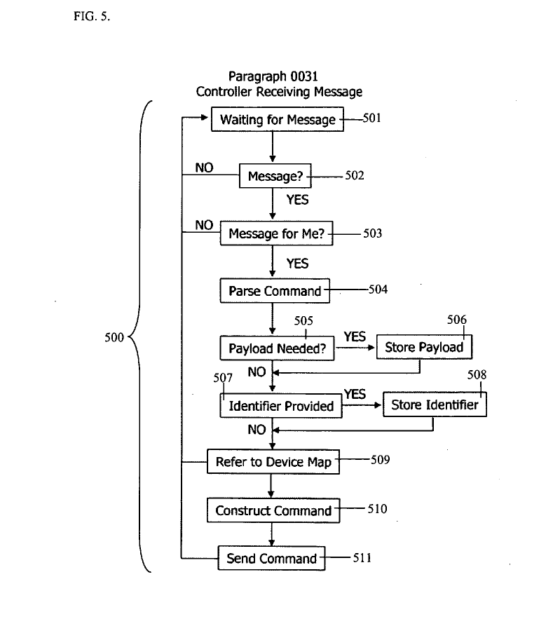

In embodiments having a remote control 180, messages sent to the DLCS 101 controller 140 from remote controls 180 can include Address, Command, Payload, and Identifier information. The Address segment in this case determines which DLCS 101 controller 140 will receive and act upon the Command message sent by the remote. FIG. 5 is a flow diagram illustrating one embodiment for a controller receiving a message and responding. The controller 140 waits for a message at step 501. At step 502, the controller 140 checks if a message has been received. If no message is received, the controller 140 returns to step 501 and waits for a message. If a message was received, the controller 140 checks, at step 503, if the message is addressed to the controller 140. If the message was not addressed to the controller 140, step 501 is returned to. If the message was addressed to the controller 140, then the controller 140 parses the commands in the message at step 504. Step 505 determines if a payload is needed. If a payload is needed, the payload is stored at step 506 and the luminaire assembly 130 proceeds to step 507. If no payload is needed, the controller 140 proceeds to step 507, where it is determined if the message included an identifier. If an identifier was provided, the identifier is stored at step 508. At step 509, the controller 140 accesses the device map information to determine the appropriate luminaire assemblies to address a command message. The command message is constructed at step 510. At step 511, a command message is sent from the controller 140 to the target luminaires or groups of luminaires. It should be noted that just as the controller has built a database of luminaires (as described above), the controller may use equivalent methods to build a database of controllers. The controller algorithms can then build relationship mappings between and among the controllers and the luminaires.

It should be appreciated that in embodiments where there is only a single controller 140 operating on the power grid 110 network, there may be no need to include Address information in the remote control's 180 transmission. In one embodiment, the controller 140 can send a message to the remote controls 180 to suppress sending of destination addresses. Additionally, since the controller 140 itself has programmed the remote controls 180 and associated each remote control 180 with the particular luminaires 120 it is to control, there may be no need for the remote control 180 to include a luminaire destination address in its Payload information. In a preferred embodiment, the remote control 180 will send a command in the Command section of its message and the remote's address in its Identifier section. Therefore, the controller 140 has no need to receive address information from the remotes controls, since the controller 140 maintains a relationship map of the remote controls 180 and the luminaires 120 they control.

### Luminaire Communication

For certain embodiments, luminaires 120 will generally send messages to the controller 140 when the controller 140 has requested a message. However, that is not a necessary requirement, as the luminaires 120 may send a message to the controller 140 without a “prompt” from the controller 140. Some illustrative exceptions to this form of operation will be described below. Luminaire messages may include Address (of the controller 140), Payload, and Identifier sections. Although, it should be noted that in embodiments where there is only one controller 140 connected to the power grid 110 there is no need for luminaires 120 to send the Address section of the message.

The luminaire 120 can respond to several types of messages. Simple control-type commands have been discussed briefly above, such as ‘ping’ and ‘identify’ commands. Also, a command instructing the luminaire 120 (or a group of luminaires 120 or all luminaires 120) to desist from including Address section data in future messages has previously been discussed.

It should be appreciated that the DLCS 101 described herein is a versatile network system that can easily host additional functionalities known in the art. While one of ordinary skill in the art should appreciate the various known functionalities that can be integrated with a DLCS 101, non-limiting examples of some such functionalities will be described below.

For example, a motion detector may be provided as part of the DLCS 101. The luminaire 120 can be equipped with the motion detector and be “aware” of its presence. The controller 140 can learn of the presence of this detection capability by polling the luminaire 120 and requesting a ‘capabilities’ response. Programming entered at the controller 140 can activate the motion sensor and request motion sensor data to be sent to the controller 140. This would allow the controller 140 to adjust lighting intensities based on occupancy determined by motion.

Alternatively, a light level sensor could be included in the DLCS 101. Light level sensor information passed to the controller 140 could allow the controller 140 to dynamically adjust lighting intensities based on ambient illumination conditions in the physical neighborhood of the sensor-quipped luminaire 120.

For embodiments where the DLCS 101 controller 140 is in communication with a computer network, such as a separate wired or wireless LAN or WAN, such sensor data can be reported to a security or building management system. These external systems can act on the data by themselves, or direct the DLCS 101 controller 140 to take action as well. Alternatively, the controller 140 may include such security and management systems within its own programming. Furthermore, the controller may instruct emergency light patterns/configurations to inform residents/employees of danger and direct them to safety. Additional non-limiting examples of sensor types that could be incorporated into the DLCS and would be useful to building security and management include thermocouples, smoke detectors, power consumption meters, and luminaire light-level sensors. The data from the latter luminaire light level sensors could warn of failing or dimming LED's (which can fail/dim both gradually over time and suddenly). These warnings, interpreted by the DLCS, could be used to schedule replacement of luminaires or schedule turn on of additional LED's or luminaires that have “slept” as installed reserve light sources.

Further, one of ordinary skill in the art will appreciate that many known network-based applications and functions may be utilized with the DLCS 101. Such applications and functions include, but are not limited to, a Web-based utility for allowing employees to adjust the illumination levels in their immediate work areas. This and other applications can provide DLCS 101-based capabilities beyond those available given the current lighting systems.

### Communication Fundamentals

Current practice provides numerous examples of communication protocols that operate over existing AC power lines. The second mode of current practice discussed above would involve the use of one such protocol. All such protocols apply high frequency signals of relatively low voltage to the AC mains, and the receiving control node separates the high frequency signals from the low frequency power main waveform. The resultant signal is further conditioned and passed to the node's internal circuitry. The internal node circuitry then modulates the AC voltage provided to the attached lighting fixture appropriately.

However, in certain embodiments, the DLCS 101 provides power to its luminaires 120 in a low voltage (preferably 24V or less) DC format rather than via AC. Consequently, the communication input/output (I/O) stage can be implemented in several different configurations

In one configuration, controller 140 communications are sent across the AC mains using one of the existing communication protocols or a DLCS proprietary protocol. At the interface between the AC mains power grid and the distributed lighting DC power grid, a translator receives the AC messaging communication and translates it into a protocol and waveform appropriate to be applied to the steady-state DC voltage grid used in the distributed lighting system.

The most important characteristic of this DLCS waveform is that is be balanced in its negative going and positive going pulses so that statistical anomalies do not cause significant variation in the DC voltage applied to the LEDs 121 within the luminaires 120.

Alternatively, the controller 140 may be configured to apply the appropriate DC signaling waveforms directly to the distributed lighting DC power grid. The selection of one system of signaling over another may depend solely on the cost of implementing one system versus another.

### Programming Luminaires

Once a set of luminaires 120 has been physically and electrically installed (such as by placing them into tiles 300 and then onto a preformed support structure) they must be programmed. This programming task need be no more complex than current practice, but it can provide capabilities far beyond current practice. One of the most common types of programming involves creating groups of luminaires 120 that will function together.

In creating such a group, current practice requires care to be taken during installation to assure that all luminaires 120 that will be controlled by a given switch, be wired together, and that a power feed wire be routed to the location of said switch and from the switch to the location of the group. In the present invention there are several ways to accomplish such a grouping, and none of the methods require routing feed wires directly to and from a dedicated switch. Additionally, all of the grouping techniques allow group members to be reassigned to and from other groups (essentially redefining the groups) without the necessity of physically rearranging the originally installed lighting components or wiring. Furthermore, even though luminaires 120 are assigned to particular groups, they are not hard-wired as in current practice and can be independently controlled or controlled as part of a different group.

In a non limiting example of such a grouping of luminaires 120, luminaires 120 are attached to a portion of the power grid 110. It is desired that this group of luminaires 120 turn on with a single switch (in the DLCS 101 a switch would be considered to be a remote control 180), just as in current practice. The grid portion is powered up, the controller 140 sends a group command, all of the subject luminaires 120 associate with the provided group address, and that address is associated with a specific switch. For embodiments utilizing a computer as a portion of the controller 140, this can be accomplished with a few keyboard commands or touch screen presses at the controller 140 or a few clicks on a computer based graphical user interface. The prior art need to pull specific wires to specific electrical boxes is eliminated. Alternatively, the needed commands can be sent from a wired or wireless handheld remote control designed for programming tasks. This allows the programmer to be distant from the controller 140, as may be the luminaires being programmed.

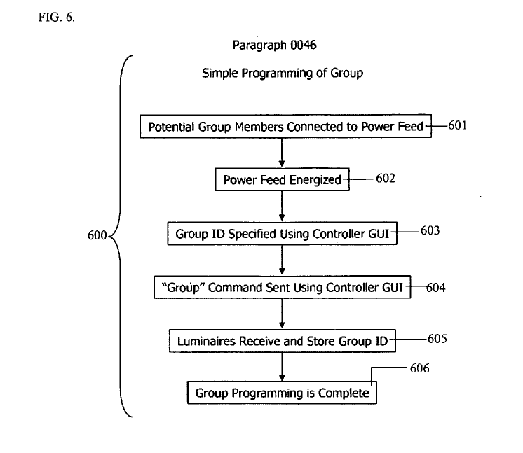

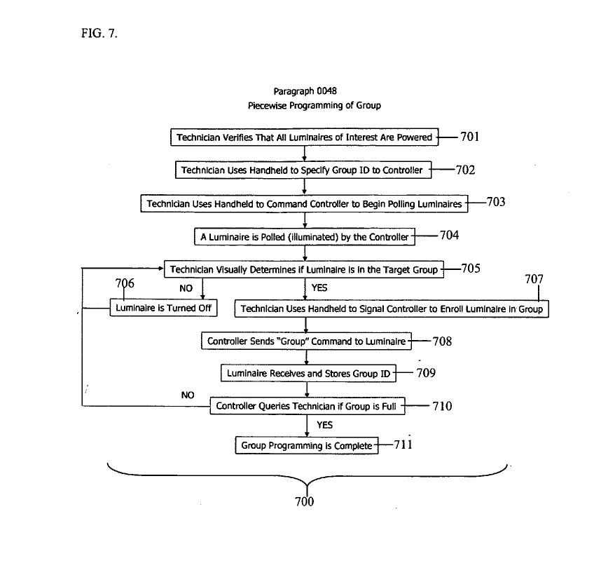

FIG. 6 illustrates one embodiment of a method 600 for selecting and assigning luminaires to a group. At step 601, the luminaire assemblies 130 that are potentially members of the group are connected to a power feed. At step 602, the power feed is energized. At step 603, a user establishes the group ID, such as via the controller's GUI. At step 604, the controller 140 sends a command to the luminaire assemblies 130 powered at step 602. At step 605, the luminaire assemblies 130 receive the command message (see, e.g., FIGS. 4A-B) and store the group ID specified at step 603.

In a second embodiment of grouping, the group of luminaires 120 is installed, and the installation technicians scan the machine-readable unique identifier 126 from each luminaire 120 either as it is installed or in a batch process shortly after the luminaires 120 are removed from their as-delivered packaging. After installation, the scanned unique identifier 126 are transferred from the scanning device either wireles sly or over a cable. One type of such a scanning device can also comprise a programming remote control as discussed above. A set of keystrokes or clicks similar to those used in the first embodiment associates the luminaires 120 as a group and associates that group with a particular switch (remote control 180).

In a third embodiment of grouping, when the installer has not captured the relevant unique identifier 126 nor isolated the power feed to the group in questions, a handheld remote control installation tool similar to the programming tools discussed above can be used to signal the controller 140 (either wirelessly or over a cable) to sequentially illuminate each of the luminaires 120 that have not yet been programmed. As each luminaire 120 activates, the installer uses the handheld installation tool to signal the controller 140 whether this luminaire 120 is or is not a member of the group being formed. When the group is complete the installer can signal the controller 140 to terminate the scan. The group is then associated with a particular switch using the controller's 140 capabilities or the handheld installation tool's capabilities.

FIG. 7 illustrates a method 700 for piecewise programming of a group for this third embodiment of grouping. At step 701 a use, such as a technician, verifies that all of the luminaires of interest are powered. At step 702, the user specified a group ID to the controller 140, such as via a portal i/o device. At step 703, the user issues command messages to the controller 140 to cause the controller 140 to begin the process of polling the luminaire assemblies 130 in communication with the controller 140. At step 704, an individual luminaire assembly 130 is polled and an indication is provided, such as by activating the luminaire 120. At step 705, the user determines if the illuminated luminaire is to be part of the group. If no, the user notifies the controller, and the controller issues a command to turn off the luminaire 120 and repeats the polling process with another luminaire assembly 130. If the luminaire 120 is to be part of the group, the user issues a command message to signal the controller to enroll the luminaire assembly 130 in the group at step 707. At step 708, the controller sends the “group” command message to the luminaire assembly 130. At step 709, the group of luminaire assemblys 130 receives the group command message and stores the group id provided in the command message. At step 710, the controller 140 queries the user to determine if the group is complete. If it is not, the process returns to step 705.

At any time, the controller 140 can be used to delete luminaires 120 from the group or add luminaires 120 to the group. Also, since optical sensors can be an integral component of the luminaire 120, the handheld programming device has the option of communicating directly with the luminaire 120 by wireless means (in those cases where the luminaire assemblies are equipped with wireless capability). In this case the luminaire 120 can relay the programming information to the controller 140 over the normal power-grid-based communication path.

The electronic circuit 132 embedded in each luminaire 120 is designed to check the address field of each transmission from the controller 140. When the circuit 132 recognizes its own unique address, its own group address (explained below), or the universal address (explained below) the luminaire 120 moves on to decode the command portion of the controller's message.

In one embodiment, additional sensors are added either internal or external to the luminaire assembly 130. In one embodiment, such sensors are handled as a capability of the luminaire 120. Then, when the controller 140 inquires about capabilities, it learns that one of the capabilities of this luminaire 120 is to report motion data or light data or whatever data the sensor provides. The controller 140 can then request that data or command the luminaire 120 to push that data on some schedule. In an alternative embodiment, the sensor behaves just as if it were a luminaire 120. Basically, it carries the same electronic package and does everything a luminaire 120 does except light up. The controller 140 would learn to poll this luminaire 120 for capabilities and get a negative response on lighting. Any and all sensor data acquired by the controller 140 can be acted upon by the controller or forwarded to connected systems to be acted upon. Layered Groups

Since the electronic circuit 132 within each luminaire 120 can learn and remember multiple group addresses, in certain embodiments the concept of layered groups may be utilized. This concept provides a dramatic extension to the currently used practices. In one example of a layered group, a given luminaire 120 can be a member of the group of luminaires 120 that turn on at the beginning of normal work hours and also a member of the group that lowers light output between 10 AM and 2 PM. In this example, not all of the ‘working hours’ luminaires 120 are members of the class of ‘mid-day dimming’ luminaires 120. Thus, luminaires 120 may be included in various overlapping groupings or grouped into various levels of sets and subsets.

Also a particular luminaire 120 could be a member of the ‘working hours’ group, as well as a member of the group of lights who adjust their output according to the local light level, as well as a member of the group of luminaires 120 who adjust their level when a particular employee is in his office.

The group address (and any other data such as dimming levels or sensor values) stored in the luminaire assembly 130 might be stored in random access memory (RAM) or electronically erasable programmable read only memory (EEPROM) or flash memory or logic registers or any other suitable type of memory. It will be understood that any such memory embedded within the luminaire 120 is considered to be part of the embedded electronic circuit 132 mentioned elsewhere in this document.

For clarity, the concept of “groups” may be utilized at various levels of granularity, for example ‘groups’ might be all the light in a room, or all the lights on the floor of a building, or all the light in a hallway, or all the light in a logical array rather than an obvious physically defined location. An example of such a logical group might be all the safety night-lights within a building.

### Load Management

In current practice there is a fundamental relationship that must exist between the grouping of lighting fixtures and the loading of breakers in the electrical box. Any group of lights that will be switched on and off by a single switch must be connected through a feed wire to a single breaker. The exception to this involves the more complicated wiring situation requiring the use of a multiple pole switch that feeds some portion of the lighting group from one pole and other portions of the group from another pole. Of course, multiple feed wires must be pulled to the switch box to implement this solution and special switches must be used to control the lighting.

The Distributed Lighting system enables the separation of lighting element control and lighting element power sourcing. During installation, the optimum loading of luminaires 120 per breaker can be achieved without concern of overloading a breaker with too many lighting elements or underutilizing a breaker box by connecting a small group to a single breaker. Once the luminaires 120 are installed to optimally utilize the power grid 110, the control paradigm can be designed using the DLCS 101 controller 140 in a manner that makes the detailed power connections of the luminaires 120 completely transparent to the lighting designer, installer, and manager.

In one embodiment, the DLCS 101 allows for a simplified wiring and design scheme. A wire is run from a breaker to an area, and then luminaires 120 are attached/assigned to it until the total maximum current draw from those luminaires 120 equals the maximum allowed current of the breaker. Then, another wire is routed from another breaker and the process is repeated. In most cases modification can be handled from the controller 140. In cases where new luminaires 120 might have to be added in the future, the number of luminaires specified to be supported by a breaker during installation should be less than the total able to be supported. Of course, this is true of both current practice installation as well. However, the DLCS 101 makes it possible to allow post-construction additions of individually controllable lighting by simply attaching additional luminaire assemblies 130 to the existing tiles/grid. This is a dramatic departure from and improvement to current practice.

### Contingencies:

As with all electronic components, there is the possibility that the circuit 132 embedded within the luminaire assembly 130 can fail during operation or even be inoperative at the time of installation. Likewise, the luminaire 120 (such an LED 121) might fail. Or a user may simply wish to replace the luminaire 120 with a different luminaire 120. The DLCS 101 provides for ease of replacement/repair. In such a case, one approach is to simply remove the luminaire 120 from its bezel within the structural component in which it is embedded and replace the luminaire 120 with a spare. The permanent unique identifier 126 of the replacement luminaire 120 can be read off its packaging and entered into the controller 140 database by hand. Alternatively, the unique identifier 126 can be read and communicated electronically to the DLCS 101 controller 140. Or the controller 140 may be prompted to generate a ‘universal ping’ command in order to learn the new unique identifier 126. After learning the unique identifier 126 of the new luminaire 120, the controller 140 can register the new device into any groups in which it is a member. It should be noted that since the already-in-place luminaires 120 have been previously registered with the controller 140, only a single ping response is necessary to register the replacement luminaire 120.

If it is desired by the operator of the distributed lighting system, this entire replacement process can be automated. The controller 140 can be programmed to poll for missing or nonfunctioning luminaires 120. The ability of the controller 140 to identify missing (or totally inoperative) luminaires 120 would be available in all cases. The ability to notify the controller 140 when the circuit 132 is intact but the LEDs 121 has failed would be an advanced feature, and the manufacturer of each luminaire circuit 132 would decide whether or not to include that capability in a particular circuit 132. If such a feature were to be included, the controller 140 would be able to poll the luminaire 120 to gain access to said feature.

Referring to failure information in its database acquired through periodic polling, the controller 140 could report failures to maintenance personnel and automatically re-enroll new luminaires 120 when the replacement is made

The failure to provide a tautology of all possible commands in no way diminishes the purpose of this document in defining the fundamental operational method of the DLCS 101 controller 140 and the system architecture that stands behind it. In fact, the inability to anticipate the complete palette of such commands expresses a key differentiation between the invention herein disclosed and current practice. Beyond that, it should be noted that none of the particular commands or protocols mentioned herein are specifically required to be part of DLCS 101 operation. They are included to make clear the nature of the system architecture and how the system operates. Any or none of these particular items may be included in a fully realized DLCS 101 system.

The present invention contemplates methods, systems and program products on any machine-readable media for accomplishing its operations. The embodiments of the present invention may be implemented using an existing computer processor, or by a special purpose computer processor incorporated for this or another purpose or by a hardwired system.

As described above, many of the embodiments include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, PROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection can properly be termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments may be described in the general context of method steps which may be implemented by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Many of the embodiments described herein may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art can appreciate that such network computing environments can typically encompass many types of computer system configurations, including personal computers, hand-held devices, multiprocessor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or various portions thereof may include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

What is claimed is:

1. A system comprising:
at least one controller including
a controller communication device,
and an interface configured to receive input; and
at least one luminaire assembly including
a luminaire communication device configured to receive information from the controller communication device, and
at least one luminaire including at least one light emitting diode,
wherein the at least one luminaire assembly is associated with a unique identifier, and wherein the at least one luminaire assembly is configured to receive energy from a direct current power grid.

2. The system of claim 1, wherein the luminaire communication device and the controller communication device are configured for bi-directional communication such that the luminaire communication device can send information to, and receive information from, the controller communication device and such that the controller communication device can send information to, and receive information from, the luminaire communication device.

3. The system of claim 1, wherein the at least one controller further includes a computer readable medium and instructions stored on the computer readable medium configured to enable communication between the at least one controller and the at least one luminaire.

4. The system of claim 1, wherein the at least one luminaire assembly includes a circuit.

5. The system of claim 4, wherein the circuit includes a microprocessor.

6. The system of claim 4, wherein the unique identifier is electronically embedded in the circuit.

7. The system of claim 6, wherein the unique identifier is a serial number.

8. The system of claim 7, wherein the serial number is indicated by a machine-readable format

9. The system of claim 7, wherein the serial number is indicated by a human-readable format.

10. The system of claim 1, wherein the at least one controller is in communication with one or more non-luminaire devices.

11. The system of claim 10, wherein the one or more non-luminaire devices are selected from the group consisting of remote controls, computer-based software applications, handheld computing devices, PDAs, smart-phones, light level sensors, and storage devices.

12. The system of claim 11, wherein the at least one controller is in communication with a remote control configured to receive user commands and transmit the user commands to the at least one controller.

13. The system of claim 11, wherein the at least one controller is in communication with one or more light level sensors, the at least one controller configured to receive light level information from the one or more light level sensors and to send commands to the at least one luminaire assembly based at least in part on the received light level information.

14. The system of claim 13, wherein the commands sent to the at least one luminaire assembly are based at least in part on a change in the received light level information.

15. The system of claim 13, wherein the at least one controller is in communication with an external building management system and the at least one controller is configured to provide the received light level information to the external building management system.

16. The system of claim 1, wherein the at least one controller is configured to select one of a steady-state current mode of operation and a pulse-width-modulating operation for the at least one luminaire.

17. A method comprising:
obtaining a unique identifier associated with each of a plurality of luminaires located in a distributed lighting system;
assigning each luminaire of the plurality of luminaires a universal identifier;
organizing the plurality of the luminaires into at least one lighting group;
assigning each luminaire of the plurality of luminaires at least one group identifier representative of a physical or task-based grouping of the plurality of luminaires;
querying a portion of the plurality of luminaries regarding the capabilities of each of the queried luminaires;
receiving information from each of the queired luminaires regarding each queried luminaire's capabilities; and
sending a command from a controller to the one or more of the plurality of luminaires based on at least one of a unique identifier, the universal identifier, and a group identifier,
wherein the controller can selectively control desired luminaires through the use of at least one of the unique identifiers, the universal identifier, and a group identifier.

18. The method of claim 17, wherein the information received from each of the queried luminaires includes address, payload and identifier information

19. The method of claim 17, wherein the command sent from the controller includes address, command, payload, and identifier information.

20. The method of claim 17, further comprising storing the received luminaire capability information in a computer readable medium.

21. The method of claim 17, further comprising sending a controller identifier to at least one luminaire of the plurality of luminaries, wherein the at least one luminaire sends all responses to the identified controller.

22. The method of claim 17, wherein obtaining the unique identifiers includes scanning each of the plurality of luminaires with a portable device and transmitting the unique identifiers associated with each of the plurality of luminaires to the controller.

23. The method of claim 17, wherein organizing each of the luminaires into at least one lighting group is a dynamic process.

24. The method of claim 17, further comprising polling the plurality of luminaries for missing or non-functional luminaires and providing a notification of same.
